(19) United States
(12) Patent Application Publication
(10) Pub. No.: US 2026/0323734 A1
(43) Pub. Date: Oct. 15, 2026

(54) METHODS AND SYSTEMS FOR MANAGING LAYER TWO TUNNELING PROTOCOL CONNECTION ESTABLISHMENT

(71) Applicant: SAMSUNG ELECTRONICS CO., LTD., Suwon-si, Gyeonggi-do (KR)

(72) Inventors: Ashok Kumar NAYAK, Bangalore (IN); Varini GUPTA, Bangalore (IN); Narendranath Durga TANGUDU, Bangalore (IN)

(21) Appl. No.: 19/101,877

(22) PCT Filed: Aug. 10, 2023
(86) PCT No.: PCT/KR2023/011866

§ 371 Date: Feb. 6, 2025

(30) Foreign Application Priority Data
Aug. 10, 2022 (IN) 202241045737
Jul. 14, 2023 (IN) 202241045737

(51) Int. Cl. H04W 76/12

(52) U.S. Cl. CPC H04W 76/12

(57) ABSTRACT

The disclosure relates to a 5G or 6G communication system for supporting a higher data transmission rate. A method per-UE formed by a first network entity associated with a session management in a communication system is provided. The method includes transmitting, to a second network entity associated with a user plane function, a first message comprising information for setting up a layer two tunneling protocol (L2TP) tunnel, and as a response to the first message, receiving, from the second network entity, a second message comprising information on a cause of a L2TP tunnel establishment failure.

### TECHNICAL FIELD

The present invention relates generally to the field of supporting point-to-point protocol (PPP) frames over an IP network, and more particularly relates to methods and systems for managing layer two tunneling protocol (L2TP) connection establishment during a data session establishment for a user equipment (UE).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### DISCLOSURE OF INVENTION

### Technical Problem

There is a need to a solution for the particular scenario when either the received L2TP information from the DN-AAA server is wrong or the locally configured L2TP information at the CP or UP is wrong.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

According to one embodiment of the present disclosure, a method performed at a first network entity for establishing a layer two tunneling protocol (L2TP) connection associated with a data session establishment for a user equipment (UE) is disclosed.

The method includes receiving a first request for establishing a data session from the UE. Further, the method includes sending a second request to a data server of a target network for data session authentication and authorization. Thereafter. The method includes receiving a first response from the data server post successful the data session authentication and authorization wherein the first response includes a plurality of parameters related to the data session establishment including L2TP information, wherein L2TP information consists of one or more tunnel parameters. Thereafter. The method includes sending a third request for establishing an L2TP tunnel for the data session establishment including the L2TP information including one or more tunnel parameters to a second network entity for L2TP tunnel establishment. Further, the method includes receiving information associated with an L2TP tunnel failure from the second network entity, wherein the L2TP tunnel failure information includes at least one cause code corresponding to one or more tunnel parameters. The method includes sending a subsequent request to the data server of the target network for receiving updated L2TP information comprising one or more updated tunnel parameters, wherein the subsequent request includes the received at least one cause code corresponding to one or more tunnel parameters. Further, the method includes receiving a second response to the subsequent request from the data server of the target network and determining whether the second response includes the updated L2TP information comprising one or more updated tunnel parameters from the data server of the target network based on the at least one cause code included in the subsequent request. Finally, the method includes sending a fourth request, upon determining that the second response includes the updated L2TP information, to the second network entity, wherein the fourth request includes one or more updated tunnel parameters for re-establishing the L2TP tunnel associated with the data session establishment.

According to one embodiment of the present disclosure, a method performed at a first network entity for establishing a layer two tunneling protocol (L2TP) connection associated with a data session establishment for a user equipment (UE). is disclosed. The method includes sending a second request to a data server of a target network for data session authentication and authorization. Further, the method includes receiving a first response from the data server post successful data session authentication and authorization wherein the first response includes a plurality of parameters related to the data session establishment. Furthermore, the method includes sending a third request for L2TP tunnel establishment including L2TP information consisting of one or more tunnel parameters to a second network entity for L2TP tunnel establishment; wherein the L2TP information is locally configured at the first network entity. After sending the third request, the method includes receiving information associated with an L2TP tunnel establishment failure from a second network entity, wherein the failure information includes at least one cause code corresponding to one or more tunnel parameters. Finally, the method includes sending by the first network entity, a data session reject message to the UE.

According to one embodiment of the present disclosure, a method performed at a second network entity, for establishing a layer two tunneling protocol (L2TP) connection associated with a data session establishment for a user equipment (UE). is disclosed. The method includes receiving a request for data session establishment from a first network entity. Thereafter, the method includes initiating an L2TP tunnel establishment using locally configured L2TP information consisting of one or more tunnel parameters. Finally, the method includes sending, to the first entity, a message indicating the re-establishment of the L2TP connection associated with a data session for the UE, after the successful establishment of the L2TP tunnel.

According to one embodiment of the present disclosure, the method performed at a second network entity, for establishing a layer two tunneling protocol (L2TP) connection associated with a data session establishment for a user equipment (UE). is disclosed. The method includes transmitting information associated with an L2TP connection failure to a first network entity, wherein the information includes at least one cause code corresponding to one or more initial tunnel parameters. Thereafter, the method includes receiving a request, including one or more updated tunnel parameters, for re-establishing the L2TP connection. Finally, the method includes sending, to the first entity, a message indicating the re-establishment of the L2TP connection associated with a data session for the UE, after the successful establishment of the L2TP tunnel.

According to another embodiment of the present disclosure, a first entity for establishing a layer two tunneling protocol (L2TP) connection associated with a data session establishment for a user equipment (UE) is disclosed. The first entity comprises a memory and a processor coupled to the memory. The processor is configured to receive a first request for establishing a data session from the UE. Further, the processor is configured to send a second request to a data server of a target network for the data session authentication and authorization. Furthermore, the processor is configured to receive a first response from the data server post successful the data session authentication and authorization wherein the first response includes a plurality of parameters related to the data session establishment including L2TP information, wherein L2TP information consists of one or more tunnel parameters. Moreover, the processor is configured to send a third request for establishing L2TP tunnel for the data session establishment including the L2TP information including the one or more tunnel parameters to a second network entity for L2TP tunnel establishment. Thereafter, the processor is configured to receive information associated with an L2TP tunnel failure from the second network entity, wherein the L2TP tunnel failure information includes at least one cause code corresponding to the one or more tunnel parameters. Furthermore, the processor sends a subsequent request to the data server of the target network for receiving an updated L2TP information comprising one or more updated tunnel parameters, wherein the subsequent request includes the received at least one cause code corresponding to the one or more tunnel parameters. Additionally, the processor receives a second response to the subsequent request from the data server of the target network and determines whether the second response includes the updated L2TP information comprising the one or more updated tunnel parameters from the data server of the target network based on the at least one cause code included in the subsequent request. Finally, the processor sends a fourth request, upon determining that the second response includes the updated L2TP information, to the second network entity, wherein the fourth request includes the one or more updated tunnel parameters for re-establishing the L2TP tunnel associated with the data session establishment.

According to another embodiment of the present disclosure, a first entity for establishing a layer two tunneling protocol (L2TP) connection associated with a data session establishment for a user equipment (UE) is disclosed. The first entity comprises a memory and a processor coupled to the memory. The processor is configured to receive a first request for establishing a data session from the UE. Further, the processor is configured to send a second request to a data server of a target network for data session authentication and authorization and receive a first response from the data server post successful data session authentication and authorization wherein the first response includes a plurality of parameters related to the data session establishment. Additionally, the processor is configured to send a third request for L2TP tunnel establishment including L2TP information consisting of one or more tunnel parameters to a second network entity for L2TP tunnel establishment; wherein the L2TP information is locally configured at the first network entity, and receive information associated with an L2TP tunnel establishment failure from a second network entity, wherein the failure information includes at least one cause code corresponding to the one or more tunnel parameters. Finally, the processor is configured to send a data session establishment reject message to the UE.

According to another embodiment of the present disclosure, a second entity for establishing a layer two tunneling protocol (L2TP) connection associated with a data session establishment for a user equipment (UE) is disclosed. The first entity comprises a memory and a processor coupled to the memory. The processor is configured to receive a request for data session establishment from a first network entity. The processor is also configured to initiate an L2TP tunnel establishment using locally configured L2TP information consisting of one or more tunnel parameters. Furthermore, the processor is configured to determine the L2TP tunnel establishment failure and send data session establishment failure message to the first network entity including at least one cause code corresponding to one or more tunnel parameters.

According to another embodiment of the present disclosure, a second entity for establishing a layer two tunneling protocol (L2TP) connection associated with a data session establishment for a user equipment (UE) is disclosed. The first entity comprises a memory and a processor coupled to the memory. The processor is configured to transmit information associated with a L2TP connection failure to a first network entity, wherein the information includes at least one cause code corresponding to one or more initial tunnel parameters. Further, the processor is configured to receive a request, including one or more updated tunnel parameters, for re-establishing the L2TP connection. Finally, the processor is configured to send, to the first entity, a message indicating re-establishment of the L2TP connection associated with a data session for the UE, after successful establishment of the L2TP tunnel.

In the embodiments of the present disclosure, methods performed at a first network entity and a second network entity for establishing an L2TP connection associated with a data session establishment for a UE are disclosed. In method performed at the first entity includes information associated with an L2TP connection failure from the second network entity are received, wherein the information includes cause code corresponding to initial tunnel parameters. Thereafter, an access request, including the cause code, is sent to a data server of a target network for receiving updated tunnel parameters; and an access response is received including the updated tunnel parameters from the data server of the target network based on the cause code included in the access request. Finally, a request is sent to the second network entity, wherein the request includes the updated tunnel parameters for re-establishing the L2TP connection associated with the data session.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### Advantageous Effects of Invention

The present disclosure provides an effective and efficient method for the particular scenario when either the received L2TP information from the DN-AAA server is wrong or the locally configured L2TP information at the CP or UP is wrong.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

These and other features, aspects, and advantages of the present subject matter will become better understood when the following detailed description is read with reference to the accompanying drawings in which like characters represent like parts throughout the drawings, wherein:

FIG. 1 illustrates a flow diagram 100 depicting the problem of L2TP tunnel establishment failure using a presently known method for establishing an L2TP connection during data session establishment, according to a conventional technique;

FIG. 2 is a schematic diagram depicting an environment for establishing a data session, according to an embodiment of the present disclosure;

FIG. 3 is a schematic diagram depicting a call flow for managing the L2TP session establishment within a single data session establishment request, according to an embodiment of the present disclosure;

FIG. 4 is a flow diagram 400 depicting a method performed at a first network entity for establishing a layer two tunneling protocol (L2TP) connection associated with a data session establishment for a user equipment (UE), according to an embodiment of the present disclosure;

FIG. 5 is a flow diagram 500 depicting the method performed at a second entity for establishing the layer two tunneling protocol (L2TP) connection associated with a data session establishment for the user equipment (UE), according to an embodiment of the present disclosure;

FIG. 6 is a flow diagram depicting another method performed at the first network entity for establishing a layer two tunneling protocol (L2TP) connection associated with a data session establishment for a user equipment (UE), according to an embodiment of the present disclosure;

FIG. 7 is a flow diagram depicting another method performed at a second network entity for establishing a layer two tunneling protocol (L2TP) connection associated with a data session establishment for a user equipment (UE), according to an embodiment of the present disclosure;

FIG. 8 illustrates an exemplary diagram of a control plane node 800, according to an embodiment of the present disclosure; and

FIG. 9 illustrates an exemplary diagram of a user plane node 900, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present subject matter. Furthermore, in terms of the construction of the device, one or more components of the device may have been represented in the drawings by conventional symbols, and the drawings may show only those specific details that are pertinent to understanding the embodiments of the present subject matter so as not to obscure the drawings with details that will be readily apparent to those of ordinary skill in the art having benefit of the description herein.

### MODE FOR THE INVENTION

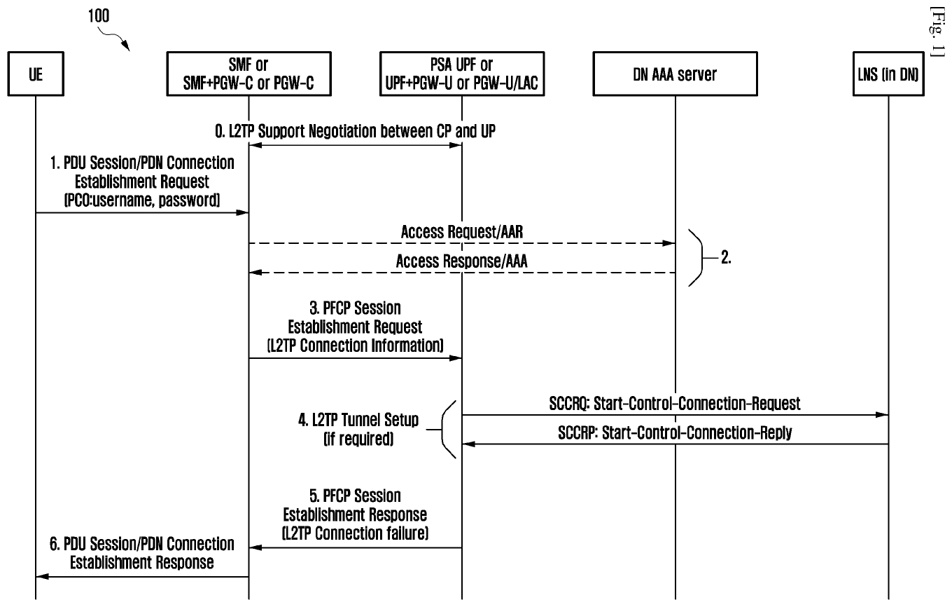

The layer two tunneling protocol (L2TP) as described in the internet engineering task force request for comments IETF RFC 2661[57] is a standard method for tunneling encapsulated point-to-point protocol (PPP) frames over a computer network that utilizes internet protocol (IP) for communication and data transmission, i.e., IP network. L2TP operates between two L2TP endpoints, i.e., L2TP access concentrator (LAC) and L2TP network server (LNS). The tunneling of PPP-encapsulated IP traffic is performed by the L2TP between the LAC and the LNS. Generally, L2TP runs over a user datagram protocol (UDP), which is a transport layer protocol of the IP suite, i.e., UDP/IP, and was originally defined for systems where PPP is used by an end-device to connect to a network via, for example, digital subscriber line (DSL) connections, or packet data protocol (PDP) in second or third generation 2G/3G context. In each of the scenarios, a LAC could be deployed in a network, for example, in a broadband network gateway (BNG) Gateway GPRS Support Node (GGSN) or packet data network gateway (PGW) to tunnel the PPP traffic to a server (for example, LNS) over an IP network. However, in the context of 4G and 5G, for a UE using an IP data session, the PPP functionality that is required to use L2TP is supported by a packet-switched access (PSA) user plane function (UPF) or user plane function of the PGW (UPF-U), a combination of UPF and PGW (UPF+PGW-U), which may be collectively referred to as user plane (UP). The PPP functionality to use L2TP is further supported by a session management function (SMF) or a control plane function of the PGW (PGW-C), or even a combination of SMF and the control plane function of the PGW (SMF+PGW-C), which may be collectively referred to as control plane (CP). For control and user plane separation (CUPS) with the UE using packet data network (PDN) or protocol data unit (PDU) connection, the PPP functionality that is required to use L2TP is supported by the CP (i.e. SMF or PGW-C or SMF+PGW-C) and UP (i.e. UPF or PGW-U or UPF+PGW-U). However, currently, when establishing a PDN or PDU session fails due to incorrect information associated with LNS, there is no way to inform about the incorrect information, as illustrated below in conjunction with FIG. 1.

FIG. 1 illustrates a flow diagram 100 depicting the problem of L2TP tunnel establishment failure using a presently known method for establishing an L2TP connection during data session establishment, according to a conventional technique. In the described method, the following sequence of events is illustrated:

Initially, at step 0, a negotiation is performed at the CP and the UP level for supporting L2TP. For example, the SMF or SMF+PGW-C or PGW-C and the UPF or UPF+PGW-U or PGW-U negotiate for supporting L2TP features as specified in 3GPP TS 29.244 in case of 5G core network (5GC). The PGW-C and PGW-U are the nodes in case of evolved packet core (EPC) or CUPS. A UE communicates with the CP for establishing a data session.

At step 1, the UE sends a data session (pertaining either to Packet Data Network, PDN in 4G or Protocol Data Unit, PDU, in both 4G and 5G) establishment request to the CP via an access and mobility management function (AMF) or a mobility management entity (MME) or a serving gateway (SGW). The CP may depend either on local L2TP configuration as defined by a data network name (DNN) or APN or the L2TP information received from a diameter network—authentication, authorization, and accounting (DN-AAA) server in an access-accept message to an access-request message for obtaining the L2TP information and include the same in a request to the UP as depicted at step 2.

Thereafter, at step 3, upon receiving the data session establishment from the UE, the CP sends a packet forwarding control protocol (PFCP) session establishment request, to the UP to establish an L2TP tunnel towards the LNS in an external DN and tunnel the data session user plane traffic in the established L2TP tunnel. Particularly, if the L2TP protocol is determined to support the data session, the CP selects a UP supporting L2TP and configured with an LAC name/address and sends the request to setup the L2TP tunnel, if needed, and thereafter initiate an L2TP session towards the L2TP network server (LNS). The CP provides L2TP information, such as LNS IP address, and tunnel password, to the UP as LAC.

Thereafter, in step 4, the UP checks if any existing L2TP tunnel can be used to serve the data session according to the information provided in the L2TP tunnel information. If a tunnel is determined to be established, the L2TP tunnel establishment is initiated using the tunnel information. However, if the L2TP information used for tunnel establishment does not contain the correct information, then the tunnel establishment fails.

Thereafter at step 5, the status of the L2TP tunnel failure is sent by the UP to the CP in a PFCP session establishment response.

Thereafter at step 6, the CP sends a data session establishment response to the UE, in the form of a data session establishment reject message.

As detailed above, in a scenario when one of the parameters like LNS address or tunnel password is wrong, the L2TP tunnel establishment fails. Consequently, for all UEs which need L2TP support, the data session requests continue to fail till the correct information is provided at the LAC (i.e., UPF or PGW-U or UPF+PGW-U).

There is a need to provide a solution for the particular scenario when either the received L2TP information from the DN-AAA server is wrong or the locally configured L2TP information at the CP or UP is wrong.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present subject matter. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

As discussed above, for establishing a data session, an L2TP tunnel may be established, and for establishing the L2TP tunnel, L2TP information may be received either from the DN-AAA server, or locally configured at a control plane node or at a user plane node of a network gateway. An object of the present disclosure is to provide a solution to the scenario when the data session establishment fails due to wrong L2TP information.

Embodiments of the present subject matter will be described below in detail with reference to the accompanying drawings.

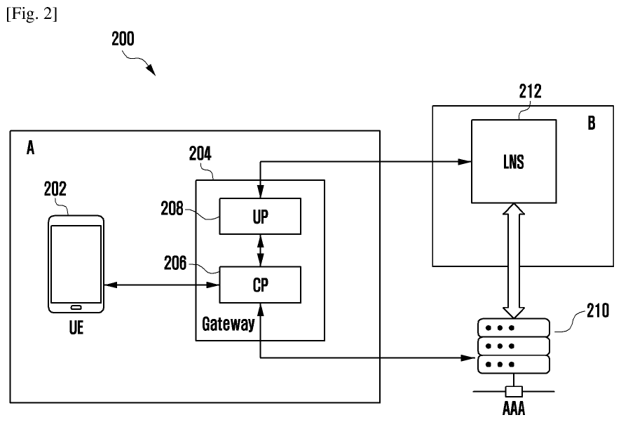

FIG. 2 is a schematic diagram depicting an environment for establishing a data session, according to an embodiment of the present disclosure. The environment 200 may comprise a UE 202, a network gateway 204, a DN-AAA server 210, and an LNS 212. The UE 202 may be connected to a network A and may be any smart device requiring a data session establishment to get some data-related services from a target network B. The UE 202 may include but is not limited to, a smartphone, tablet, or the like. The data session may correspond to a packet data network (PDN) session in the context of 4G, or a protocol data unit (PDU) session in the context of 5G. When the data session establishment is required, the UE 202 may communicate with the network gateway 204 by sending a request for establishing the data session via an access and mobility management function (AMF) or a mobility management entity (MME) or a serving gateway (SGW). The network gateway may comprise a control plane node (CP) 206, and a user plane node (UP) 208, as depicted in FIG. 2. In an example, the network gateway 204 may be a packet data network gateway (PGW) having a control plane function (PGW-C), and a user plane function (PGW-U). The data session establishment request from the UE 202 may be received by the control plane node 206. In an embodiment of the present disclosure, the CP 206 may be a PGW-C, or a session management function (SMF), or a combination of SMF and PGW-C (SMF+PGW-C). In an embodiment of the present disclosure, the UP 208 may be a packet-switched access (PSA) user plane function (UPF) or a user plane function of the PGW(UPF-U), or a combination of UPF and PGW (UPF+PGW-U). The UP 208 may receive a request for establishing an L2TP tunnel from the CP 206. As discussed above, an L2TP tunnel is established between an L2TP access concentrator (LAC) and an L2TP network server (LNS) 212. In an embodiment of the present disclosure, the UP, i.e., the PSA UPF or UPF+PGW-U or PGW-U, may support L2TP and may be configured to act as the L2TP access concentrator (LAC). The CP 206 may provide L2TP information to the UP 208 as LAC. The L2TP information relates to L2TP tunnel parameters which may include necessary parameters for setting up the L2TP tunnel towards the LNS 212 of the target network B, such as, but not limited to, LNS IP address, tunnel password, or fully qualified domain name (FQDN) of the LNS, as described in 3GPP TS 29.244.

In some embodiments of the present disclosure, the CP 206 may be communicatively coupled with the DN-AAA server 210. The DN-AAA server 210 may be configured to provide, among other information related to the SMF invoking the DN-AAA server for secondary PDU authentication and authorization, the L2TP information to the CP 206, whenever requested. In an alternate embodiment, the L2TP information may be stored in 5GC or evolved packet core (EPC) as part of local configuration. In another alternative embodiment of the present disclosure, the L2TP information may be configured on the CP 206, i.e., SMF or SMF+PGW-C or PGW-C, as part of an APN or DNN configuration. In another alternative embodiment of the present disclosure, the L2TP tunnel parameters may also be locally configured in the UP 208, i.e., UPF or UPF+PGW-U or PGW-U as part of an APN or DNN configuration at the UP. The UP 208 sends a request to establish an L2TP session towards the LNS 212. The LNS 212 may be a server supporting L2TP and configured as an L2TP network server at the target network B.

According to the embodiments of the present disclosure, the L2TP tunnel establishment may fail when the L2TP information is incorrect. For example, the LNS IP address may be incorrect. In another example, the tunnel password may be incorrect. The object of the present disclosure is to manage the successful establishment of an L2TP session using the L2TP information in multiple scenarios, to result in a successful data session establishment. One scenario may be managing the L2TP session establishment within a single data session establishment request. A second scenario may be managing the L2TP session establishment for subsequent data session establishment requests after the failure of a previous data session establishment request. A third scenario may be managing the L2TP session establishment when the L2TP information locally configured at the CP 206 is incorrect. A final scenario may be managing the L2TP session establishment when the L2TP information locally configured at UP 208 is incorrect.

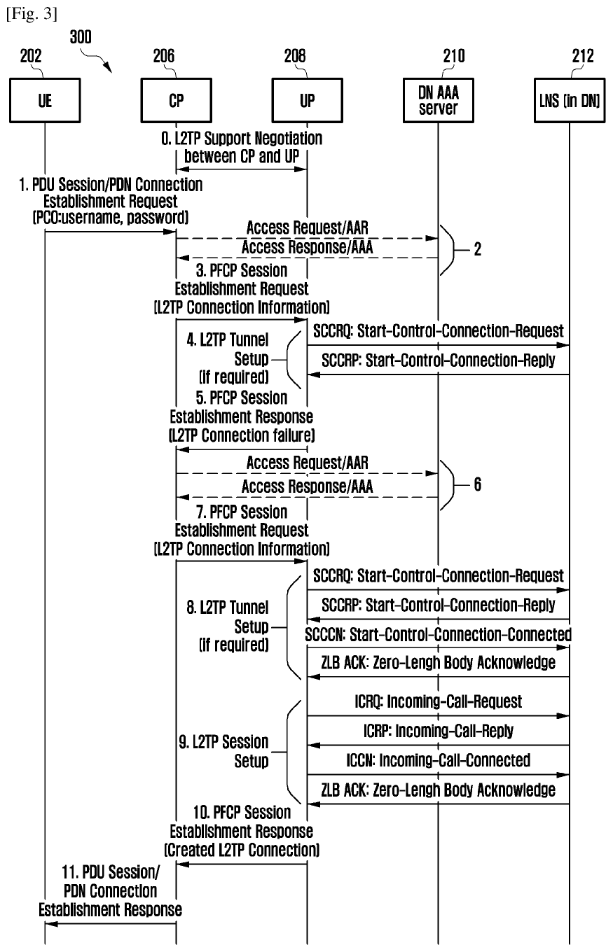

FIG. 3 is a schematic diagram depicting a call flow for managing the L2TP session establishment within a single data session establishment request, according to an embodiment of the present disclosure. According to the embodiments of the present disclosure, the CP 206, after receiving L2TP tunnel failure information from UP 208 in a PFCP session establishment response, may again contact the DN-AAA server 210 by sending an access request in a RADIUS message or Authorization Authentication Request (AAR) in a DIAMETER message based on the protocol supported between the CP 206 and the DN-AAA server 210. The CP 206 may use a new Attribute Value Pair (AVP) or an existing AVP to inform the DN-AAA server that the given L2TP information is incorrect due to which an L2TP tunnel could not be established. Thereafter, the DN-AAA server 210 may send updated L2TP information in an access-response in a RADIUS message or Authorization Authentication-Answer in a DIAMETER message. The CP 206 may again send a request to the UP 208 using the received updated L2TP information to establish the L2TP tunnel for successful data session establishment. The call flow for managing the L2TP session establishment within a single data session establishment request is described step-wise in the following paragraphs.

At step 0, the CP 206 (SMF or SMF+PGW-C or PGW-C) may have negotiated with the UP 208 for supporting the L2TP feature as specified in 3GPP TS 29.244 in the context of 5GC.

At step 1, the CP 206 may receive a data session establishment request from the UE 202 via AMF or MME or SGW. As depicted in FIG. 3, the data session establishment request may be for a PDN session or a data session. In an embodiment, the 202 UE may include authentication information for password authentication protocol (PAP) and/or challenge handshake authentication protocol (CHAP) in the extended protocol configuration option (ePCO) information element. The CP 206 may locally configure the UE authentication information for a given DNN or APN. The CP 206 may determine that an L2TP session is required for establishing the requested data session. In an embodiment, the CP 206 may receive L2TP information for establishing an L2TP session from the DN-AAA server 210.

For each data session establishment request received from the UE, the CP 206 checks for L2TP information. If the L2TP information is not locally configured, then the CP 206 may send the request to DN-AAA to receive the L2TP information. At step 2, the CP 206 may receive the L2TP information including the tunnel parameters such as, but not limited to, LNS IP address or FQDN, and tunnel password, from the DN-AAA server 210 in Access-Accept RADIUS message or AAA DIAMETER message.

At step 3, the CP 206 then requests the UP 208 to set up an L2TP tunnel and L2TP session towards the LNS 212. In an embodiment, the CP 206 may send a PFCP session establishment request to the UP 208, which may include L2TP tunnel information for setting up an L2TP tunnel and L2TP session information to set up an L2TP session, with additional information (PAP/CHAP authentication information) for authentication during L2TP tunnel setup, as well as for the L2TP session. The L2TP tunnel information may include the LNS IPv4 address or IPv6 address of LNS, and tunnel password. The L2TP session information may include specific information related to the data session. For example, for data Session, e.g., a calling number which may be set to UE's generic public subscription identifier (GPSI), an indication to instruct that the UP 208 may request the LNS 212 to allocate an IP address for the data Session, indications to instruct that the UP 208 may request the LNS 212 to provide DNS server addresses or NetBIOS name service (NBNS) server addresses etc. as specified in 3GPP TS 29.244.

At step 4, the UP 208 may check if any existing L2TP tunnel can be used to serve the data session based on the information provided in the L2TP tunnel information. In an embodiment, if a new L2TP tunnel setup is required, the UP 208 may initiate L2TP tunnel establishment by sending an SCCRQ (Start-Control-Connection-Request) message towards the LNS 212, the UP 208 may be allocated a tunnel ID, and it may include a CHAP Challenge to authenticate the LNS 212. The Challenge and Challenge Response (may be included in Start-Control-Connection-Connected (SCCCN) message) may be produced by UP 208 using the tunnel password received from CP 206. The LNS may respond with a Start-Control-Connection-Reply (SCCRP) message, including its allocated tunnel ID and a CHAP Challenge Response to the Challenge in SCCRQ. At this point, if the L2TP information that the UP 208 used for tunnel establishment is not correct, for example, incorrect LNS server address or tunnel password, then tunnel establishment fails. When UP 208 may receive at least one cause code from the LNS 212 indicating a reason for the tunnel establishment failure. In an embodiment, the cause code maybe 87 and 89 for tunnel authentication. The cause code 87 may correspond to an incorrect password, and the cause code 89 may correspond to the non-reachability of the LNS 212 due to an incorrect IP address.

At step 5, the status of the L2TP tunnel failure may be sent by the UP 208 to the CP 206 in a PFCP session establishment response. The PFCP session establishment response to the CP 206 may include the at least one cause code. Using cause code, the CP 206 may correlate the exact failure of the L2TP tunnel and accordingly inform the DN-AAA server 210.

At step 6, the CP 206 may contact the DN-AAA server 210 by sending an access-request (RADIUS) message or AA-request (DIAMETER) message based on protocol supported by the DN-AAA server, including at least one cause code. In the message, the CP 206 may use a new AVP or an existing AVP to inform DN-AAA server 210 that the L2TP information is incorrect due to which L2TP connection could not be established and thus, the L2TP tunnel could not be set up. Then DN-AAA server may send updated L2TP information to the CP 206 in Access-response (RADIUS) or AA-Answer (DIAMETER) message.

At step 7, the CP 206 may send the updated received L2TP information along with other information as described in step 3 in the PFCP session establishment request to the UP 206, for re-establishing the L2TP connection.

At step 8, UP 208 may attempt to establish an L2TP tunnel using the updated received L2TP information. The UP 208 may perform a similar step as described in reference to step 4 and is not repeated here for the sake of brevity.

At step 9, once the L2TP tunnel is established between the LAC (i.e., UP 208) and the LNS 212 for the data session requested by the UE 202, the UP 208 may proceed with the L2TP session setup towards the LNS 212. The UP 208 may send an Incoming-Call-Request (ICRQ) message towards the LNS 212, which includes the tunnel ID assigned by the LNS, the assigned session ID, and optionally, the calling number and the called number. The LNS 212 may respond with an Incoming-Call-Reply (ICRP) message and provide the Session ID assigned by the LNS 212 to the LAC. The LAC may then send an Incoming-Call-Connected(ICCN) message. In an embodiment, if proxy link control protocol (LCP) and authentication are employed, the ICCN message may include link control parameters (e.g., maximum receive unit, MRU) and the UE authentication information sent from CP 206 which was received via ePCO IE in step 1. Additionally, the UP 208 (LAC) may act as a PPP endpoint to use IPCP to request UE IP Address, DNS server address and/or NBNS server address(es). The LCP renegotiation may be triggered by the LNS 212 after receiving the ICCN message. In such case, if the LAC and LNS may use PPP LCP to communicate link-specific control parameters, and indicate authentication type, then PPP PAP/CHAP may take place. The PPP IPCP transactions may take place to retrieve UE IP Address, DNS server address and/or NBNS server address.

Thereafter, at step 10, the status of the L2TP session setup may be sent by the UP 208 to the CP 206 in a PFCP Session Establishment Response.

Finally, at step 11, the CP 208 may send a session establishment response (for example, data session establishment response) to the UE 202 and the data session may be initiated, which may contain the DNS and NBNS Server information. In the above-described scenario, the data session is successfully established within a single request by the UE 202.

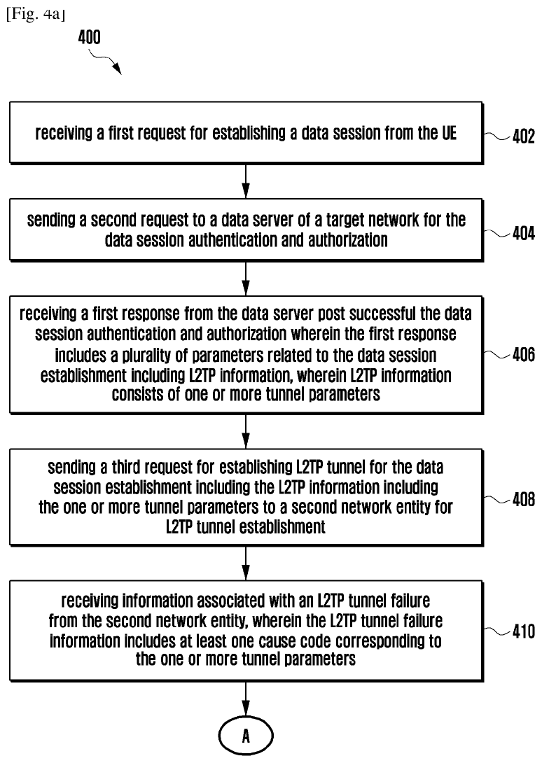

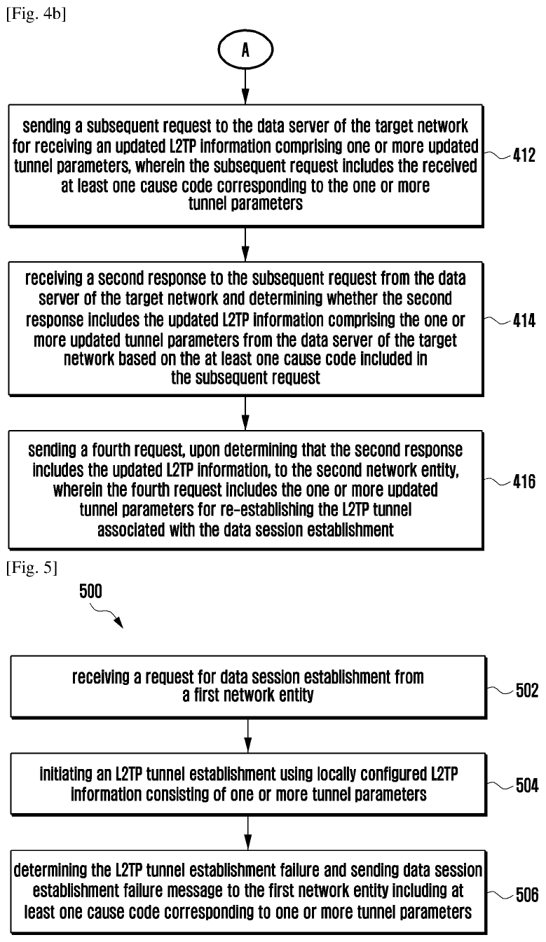

The underlying method for the above-described call flow for managing the L2TP session establishment within a single data session establishment request may be described in conjunction with FIGS. 4a, 4b, and 5.

FIG. 4 is a flow diagram 400 depicting a method performed at a first network entity for establishing a layer two tunneling protocol (L2TP) connection associated with a data session establishment for a user equipment (UE), according to an embodiment of the present disclosure. The first entity may correspond to the CP 206. In an embodiment, the first entity is the first network entity is either a session management function (SMF) or a combination of SMF and a control plane function of the packet data network gateway (PGW) (SMF+PGW-C) or a control plane function of the packet network gateway (PGW-C). In an embodiment, the data session establishment request is a request for establishing either a protocol data unit (PDU) session or a packet data network (PDN) session. At step 402, the method may include receiving a first request for establishing a data session from the UE. in an embodiment, the first request for the data session establishment from the UE is either a first data session establishment request from the UE or a second data session establishment from the UE or a data session establishment request from another UE. Thereafter, at step 404, the method may include sending a second request to a data server of a target network for the data session authentication and authorization. In an embodiment, the data server of the target network is a diameter network—authentication, authorization, and accounting (DN-AAA) server. Thereafter, at step 406, the method may include receiving a first response from the data server post successful the data session authentication and authorization wherein the first response includes a plurality of parameters related to the data session establishment including L2TP information, wherein L2TP information consists of one or more tunnel parameters. Thereafter, at step 408, the method may include sending a third request for establishing L2TP tunnel for the data session establishment including the L2TP information including the one or more tunnel parameters to a second network entity for L2TP tunnel establishment. In an embodiment, the second network entity is either a user plane function (UPF) or a combination of the UPF and user plane function of the PGW (UPF or UPF+PGW-U) or user plane function of the PGW (PGW-U).

Thereafter, at step 410, the method may include receiving information associated with an L2TP tunnel failure from the second network entity, wherein the L2TP tunnel failure information includes at least one cause code corresponding to the one or more tunnel parameters. Thereafter, at step 412, the method may include sending a subsequent request to the data server of the target network for receiving an updated L2TP information comprising one or more updated tunnel parameters, wherein the subsequent request includes the received at least one cause code corresponding to the one or more tunnel parameters. Thereafter, at step 414, the method may include receiving a second response to the subsequent request from the data server of the target network and determining whether the second response includes the updated L2TP information comprising the one or more updated tunnel parameters from the data server of the target network based on the at least one cause code included in the subsequent request. Finally, at step 416, the method may include sending a fourth request, upon determining that the second response includes the updated L2TP information, to the second network entity, wherein the fourth request includes the one or more updated tunnel parameters for re-establishing the L2TP tunnel associated with the data session establishment. In an embodiment, the method further includes sending to the data server of the target network, the subsequent request including the at least one cause code corresponding to the one or more tunnel parameters, for the data server to update L2TP information comprising one or more tunnel parameters based on the at least one cause code and receiving from the data server of the target network, the updated L2TP information. The above method describes the steps performed at the CP 206.

In an embodiment, there may be a scenario when the L2TP information is neither received from the DN-AAA server 210, nor locally configured at the CP 206, but locally configured at the UP 208. In such a case, when the tunnel establishment fails, an alert may be generated at an interface of the UP 208 for updating the locally configured L2TP information. An underlying method for the steps performed at the UP 208 related to the above-discussed scenario may be described in conjunction with FIG. 5.

FIG. 5 is a flow diagram 500 depicting the method performed at a second entity for establishing a layer two tunneling protocol (L2TP) connection associated with a data session establishment for a user equipment (UE), according to an embodiment of the present disclosure. The second entity may correspond to the UP 208. Firstly, at step 502, the method may include receiving a request for data session establishment from a first network entity. Thereafter, at step 504, the method may include initiating an L2TP tunnel establishment using locally configured L2TP information consisting of one or more tunnel parameters. Upon initiating the L2TP tunnel establishment, the method may include, at step 506, determining the L2TP tunnel establishment failure and sending data session establishment failure message to the first network entity including at least one cause code corresponding to one or more tunnel parameters. In an embodiment, upon determining the L2TP tunnel establishment failure, the method may include raising an alarm to a network operator indicating failure of L2TP tunnel establishment due to at least one cause code corresponding to one or more tunnel parameters and receiving by the network operator one or more updated tunnel parameters based on the raised alarm.

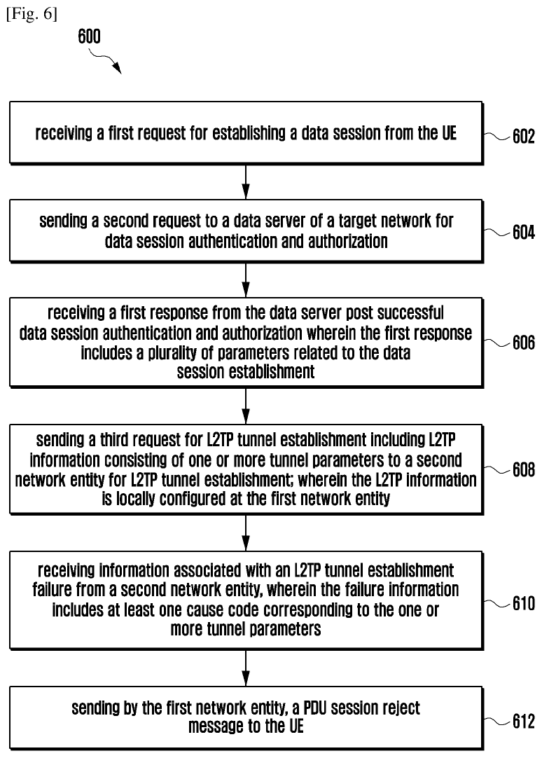

In an embodiment, there may be a scenario, at step 6, when the CP 206 sends an access request, including the at least one cause code, for receiving updated L2TP information, the DN-AAA server 210 may send an access response, while the access response may not include the updated L2TP information expected by the CP 206. In such a scenario, the data session establishment fails in the single request. However, the data session establishment failure may be prevented for subsequent future data session establishment requests. As discussed above, the CP 206 checks for L2TP information for each data session establishment request and sends an AA-request to the DN-AAA server 210 for receiving the L2TP information when not found locally configured at the CP 206. Since the DN-AAA sever 210 was informed in the previous access request (at step 6) with the at least one cause code, the DN-AAA server 210 may send the updated L2TP information in response to the AA request associated with the subsequent data session establishment request. Thereafter, the CP 206 may proceed with the L2TP flow as per TS 29.561, using the updated L2TP information. Thus, the data session may be successfully established for the subsequent request. In an exemplary embodiment, if the L2TP information is received from DN-AAA server during secondary PDU Authentication & Authorization as part of the DN Authorization data then CP 206 after receiving the L2TP failure from the UP 208 may trigger diameter EAP request (DER) message to DN-AAA server 210 using a new AVP or an existing AVP informing that given L2TP information is incorrect because of which L2TP tunnel could not be established. Then DN-AAA server 210 may send the updated L2TP information in the DN authorization data. Thereafter, the CP 206 may proceed with the L2TP flow as per TS 29.561. An underlying method for the above-discussed scenario may be described in conjunction with FIG. 6.

FIG. 6 is a flow diagram depicting another method performed at the first network entity for establishing a layer two tunneling protocol (L2TP) connection associated with a data session establishment for a user equipment (UE), according to an embodiment of the present disclosure. As discussed above, the first entity may correspond to the CP 206. At step 602, receiving a first request for establishing a data session from the UE. Thereafter, at step 604, the method may include sending a second request to a data server of a target network for data session authentication and authorization. Thereafter, at step 606, the method may include receiving a first response from the data server post successful data session authentication and authorization wherein the first response includes a plurality of parameters related to the data session establishment. Thereafter, at step 608, the method may include sending a third request for L2TP tunnel establishment including L2TP information consisting of one or more tunnel parameters to a second network entity for L2TP tunnel establishment; wherein the L2TP information is locally configured at the first network entity. Upon sending the third request, the method may include, at step 610, receiving information associated with an L2TP tunnel establishment failure from a second network entity, wherein the failure information includes at least one cause code corresponding to the one or more tunnel parameters. In an embodiment, raising an alarm to a network operator indicating failure of L2TP tunnel establishment due to at least one cause code corresponding to the one or more tunnel parameters and receiving from the network operator one or more updated tunnel parameters based on the raised alarm. Finally, at step 612, the method may include sending by the first network entity, a data session reject message to the UE.

In an embodiment, the L2TP information may be locally configured at the CP 206. The CP 206 includes the locally configured L2TP information in the PCFP session establishment request (at step 3) to the UP 208. As discussed above, the UP 208 may use the L2TP information received from the CP 206 to set up an L2TP tunnel with the LNS 212. In such an example, when the tunnel establishment fails, the UP 208 informs the CP 206 in a PFCP session establishment response with the L2TP connection failure message. Thereafter, an alert may be generated at an interface of the CP 206 for updating the locally configured L2TP information.

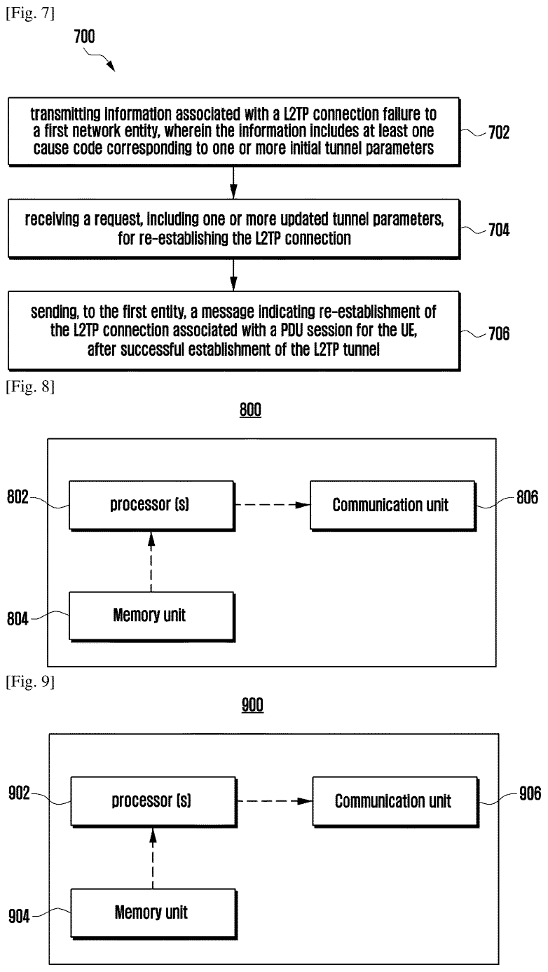

FIG. 7 is a flow diagram depicting another method performed at a second network entity for establishing a layer two tunneling protocol (L2TP) connection associated with a data session establishment for a user equipment (UE), according to an embodiment of the present disclosure. As discussed above, the second entity may correspond to the UP 208. At step 702, the method may include transmitting information associated with an L2TP connection failure to a first network entity, wherein the information includes at least one cause code corresponding to one or more initial tunnel parameters. Thereafter, at step 704, the method may include receiving a request, including one or more updated tunnel parameters, for re-establishing the L2TP connection. Finally, at step 706, the method may include sending, to the first entity, a message indicating the re-establishment of the L2TP connection associated with a data session for the UE, after the successful establishment of the L2TP tunnel.

In an embodiment, before transmitting the information associated with the L2TP connection failure to the first network entity, the method may include at least one of identifying, by the second network entity, non-reachability of the network server due to incorrect IP address or identifying by the second network entity, tunnel authentication failure due to wrong password.

FIG. 8 illustrates an exemplary diagram of a control plane node 800, according to an embodiment of the present disclosure. The control plane node 800 may correspond to SMF or PGW-C or a combination thereof, as discussed throughout this disclosure. The control plane node 800 may include at least one processor 802, a memory unit 804 (e.g., storage), and a communication unit 806 (e.g., communicator or communication interface). The communication unit 806 may perform one or more functions for transmitting and receiving signals via a wireless channel.

As an example, the processor 802 may be a single processing unit or a number of units, all of which could include multiple computing units. The processor 802 may be implemented as one or more microprocessors, microcomputers, microcontrollers, digital signal processors, central processing units, state machines, logic circuitries, and/ or any devices that manipulate signals based on operational instructions. Among other capabilities, the processor 802 is configured to fetch and execute computer-readable instructions and data stored in the memory. The processor 802 may include one or a plurality of processors. At this time, one or a plurality of processors 802 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 802 may control the processing of the input data in accordance with a predefined operating rule or artificial intelligence (AI) model stored in the non-volatile memory and the volatile memory, i.e., memory unit 904. The predefined operating rule or artificial intelligence model is provided through training or learning.

The memory 804 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

FIG. 9 illustrates an exemplary diagram of a user plane node 900, according to an embodiment of the present disclosure. Hereinafter, it is understood that terms including “unit” or “module” at the end may refer to the unit for processing at least one function or operation and may be implemented in hardware, software, or a combination of hardware and software.

Referring to FIG. 9, the user plane node 900 may include at least one processor 902, a communication unit 904 (e.g., communicator or communication interface), and a storage unit 906 (e.g., storage). The user plane node 900 may correspond to UPF or PGW-U or a combination thereof, as discussed throughout this disclosure. The communication unit 904 may perform functions for transmitting and receiving signals via a wireless channel.

As an example, the processor 902 may be a single processing unit or a number of units, all of which could include multiple computing units. The processor 902 may be implemented as one or more microprocessors, microcomputers, microcontrollers, digital signal processors, central processing units, state machines, logic circuitries, and/ or any devices that manipulate signals based on operational instructions. Among other capabilities, the processor 902 is configured to fetch and execute computer-readable instructions and data stored in the memory. The processor 902 may include one or a plurality of processors. At this time, one or a plurality of processors 902 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 902 may control the processing of the input data in accordance with a predefined operating rule or artificial intelligence (AI) model stored in the non-volatile memory and the volatile memory, i.e., memory unit 904. The predefined operating rule or artificial intelligence model is provided through training or learning.

The memory 904 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The other entities such as a user equipment (UE), a DN-AAA server and an L2TP network server (LNS), as discussed throughout this disclosure, may also have a similar architecture, and are not described herein for the sake of brevity.

At least by virtue of the aforesaid, the present subject matter at least provides various advantages. Firstly, a data session can be successfully established within a single request when the updated L2TP information is received immediately from the DN-AAA server in response to the AA request including at least one cause code. Secondly, even when the data session establishment fails in a first request due to non-reception of the updated L2TP information from the DN-AAA server, failure of the subsequent data session establishment may be prevented as the DN-AAA server was already informed about incorrect L2TP information via the at least one cause code, and now, may share the updated L2TP information. The present disclosure further enables updating the locally configured L2TP information either at the CP or at the UP, by generating alerts.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method performed by a first network entity associated with a session management in a communication system, the method comprising:
transmitting, to a second network entity associated with a user plane function, a first message comprising information for setting up a layer two tunneling protocol (L2TP) tunnel; and
as a response to the first message, receiving, from the second network entity, a second message comprising information on a cause of an L2TP tunnel establishment failure.

2. The method of claim 1, further comprising:
receiving, from a diameter network—authentication, authorization, and accounting (DN-AAA) server, the information for setting up the L2TP tunnel.

3. The method of claim 1,
wherein the information for setting up the L2TP tunnel comprises at least one of information on an internet protocol (IP) address of an L2TP network server (LNS), or information on a tunnel password,
wherein the first entity comprises at least one of a session management function (SMF), or a combination of SMF and a control plane function of the packet data network gateway (PGW) (SMF+PGW-C), and
wherein the second entity comprises at least one of a user plane function (UPF) or a combination of the UPF and user plane function of the PGW (UPF+PGW-U).

4. The method of claim 1,
wherein the information on the cause of the L2TP tunnel establishment failure comprises at least one of a cause value indicating a tunnel authentication failure, or a cause value indicating a non-reachability to an L2TP network server (LNS).

5. A method performed by a second network entity associated with a user plane function in a communication system, the method comprising:
receiving, from a first network entity associated with a session management, a first message comprising information for setting up a layer two tunneling protocol (L2TP) tunnel; and
as a response to the first message, transmitting, to the first network entity, a second message comprising information on a cause of an L2TP tunnel establishment failure.

6. The method of claim 5,
wherein the information for setting up the L2TP tunnel is received from a diameter network—authentication, authorization, and accounting (DN-AAA) server.

7. The method of claim 5,
wherein the information for setting up the L2TP tunnel comprises at least one of information on an internet protocol (IP) address of an L2TP network server (LNS), or information on a tunnel password,
wherein the first entity comprises at least one of a session management function (SMF), or a combination of SMF and a control plane function of the packet data network gateway (PGW) (SMF+PGW-C), and
wherein the second entity comprises at least one of a user plane function (UPF) or a combination of the UPF and user plane function of the PGW (UPF+PGW-U).

8. The method of claim 5, wherein the information on the cause of the L2TP tunnel establishment failure comprises at least one of a cause value indicating a tunnel authentication failure, or a cause value indicating a non-reachability to an L2TP network server (LNS).

9. A first network entity associated with a session management in a communication system, the first network entity comprising:
a transceiver;
at least one processor coupled with the transceiver and configured to:
transmit, to a second network entity associated with a user plane function, a first message comprising information for setting up a layer two tunneling protocol (L2TP) tunnel, and
as a response to the first message, receive, from the second network entity, a second message comprising information on a cause of an L2TP tunnel establishment failure.

10. The first network entity of claim 9, wherein the at least one processor further configured to:
receive, from a diameter network—authentication, authorization, and accounting (DN-AAA) server, the information for setting up the L2TP tunnel.

11. The first network entity of claim 9,
wherein the information for setting up the L2TP tunnel comprises at least one of information on an internet protocol (IP) address of an L2TP network server (LNS), or information on a tunnel password,
wherein the first entity comprises at least one of a session management function (SMF), or a combination of SMF and a control plane function of the packet data network gateway (PGW) (SMF+PGW-C), and
wherein the second entity comprises at least one of a user plane function (UPF) or a combination of the UPF and user plane function of the PGW (UPF+PGW-U).

12. The first network entity of claim 9, wherein the information on the cause of the L2TP tunnel establishment failure comprises at least one of a cause value indicating a tunnel authentication failure, or a cause value indicating a non-reachability to an L2TP network server (LNS).

13. A second network entity associated with a user plane function in a communication system, the second network entity comprising:
a transceiver;
at least one processor coupled with the transceiver and configured to:
receive, from a first network entity associated with a session management, a first message comprising information for setting up a layer two tunneling protocol (L2TP) tunnel, and
as a response to the first message, transmit, to the first network entity, a second message comprising information on a cause of an L2TP tunnel establishment failure.

14. The second network entity of claim 13,
wherein the information for setting up the L2TP tunnel is received from a diameter network—authentication, authorization, and accounting (DN-AAA) server,
wherein the first entity comprises at least one of a session management function (SMF), or a combination of SMF and a control plane function of the packet data network gateway (PGW) (SMF+PGW-C), and
wherein the second entity comprises at least one of a user plane function (UPF) or a combination of the UPF and user plane function of the PGW (UPF+PGW-U).

15. The second network entity of claim 13,
wherein the information for setting up the L2TP tunnel comprises at least one of information on an internet protocol (IP) address of an L2TP network server (LNS), or information on a tunnel password, and
wherein the information on the cause of the L2TP tunnel establishment failure comprises at least one of a cause value indicating a tunnel authentication failure, or a cause value indicating a non-reachability to the LNS.
